(19) United States
(12) Patent Application Publication
(10) Pub. No.: US 2002/0152282 A1
(43) Pub. Date: Oct. 17, 2002

(54) USE OF A PAIR MADE UP OF A CALL NUMBER AND OF AN INTERNET ORIGINATING ADDRESS

(76) Inventor: PATRICE BLEUSE, LA VILLE DU BOIS (FR)

Correspondence Address: SUGHRUE MION ZINN MACPEAK & SEAS, 2100 PENNSYLVANIA AVENUE NW, SUITE 800, WASHINGTON, DC, 200373702

(21) Appl. No.: 09/298,608

(22) Filed: Apr. 26, 1999

(30) Foreign Application Priority Data
Apr. 30, 1998 (FR) 98 05539

(51) Int. Cl. G06F 15/16; H04M 11/00; G06F 15/177

(52) U.S. Cl. 709/218; 709/222; 379/93.02

(57) ABSTRACT

The invention relates to a method of personalizing access to the Internet via the telephone network, and via a service provider; it proposes to determine the identity of a user on the basis of the originating or destination address of an Internet packet sent or received by the user, and on the basis of the pair formed firstly by the user's call number on the telephone network, and secondly by the Internet address allocated to the user by the service provider. This makes it possible to execute a service as a function of the identity determined in this way. The invention makes it possible to find out the identity of a contravening user merely on the basis of the interchanged Internet packets, and of the relationship expressed above. It is applicable in particular to filtering and to keeping traces of the filtered transactions.

The present invention relates to a method and to a system for personalizing Internet access.

The invention relates to accessing networks, and in particular to accessing the Internet. In the description below, the Internet is used by way of example, it being understood that the invention is also applicable to other networks.

### BACKGROUND OF THE INVENTION

Generally, a user accesses the Internet from a user terminal by going via the telephone network so as to set up a call to an Internet Service Provider (ISP). The telephone network may be the conventional switched telephone network, a public mobile network, or a digital network such as the Integrated Services Digital Network. The Internet service provider dynamically allocates an Internet address to the user, and enables said user to transmit calls to Contents Providers and to receive calls therefrom using the Internet Protocol.

The term “intelligent network services” is used to cover all “added value” services provided by telephone network operators in addition to mere line set up and charging services. For example, such intelligent network services may include call forwarding, pre-payment, freephone, special charging services related to certain calls, authenticating the caller, and others.

The rapid development of the Internet is posing new problems. In terms of contents, information available on the network may shock (in particular erotic information), or its dissemination may be illegal in certain contexts (some political information). Depending on the use that is to be made of the network, certain forms of filtering may be desired: filtering by parents of children's access to the network; filtering by governments of information disseminated on their territories by the network; and filtering by firms of employees' access to the network.

Various solutions have been proposed for filtering information obtained on the network. Software products designed to be installed on a user terminal make it possible to filter access to certain Internet sites. Such products are limited, and they suffer from the following drawbacks: filtering by site name is difficult to implement insofar as it requires continuous updating. Such updating is difficult to perform in practice in view of the large number of new sites created every day, and in view of how easy it is technically to transfer a site to another Internet address. Finally, such filtering systems are relatively easy to deactivate, e.g. by means of information available on the network.

### OBJECTS AND SUMMARY OF THE INVENTION

The invention proposes a solution to the problem of filtering transactions on a network such as the Internet. It makes it possible to monitor the filtering effectively. It thus guarantees that the filtering functions are effective and are better controlled.

More precisely, the invention provides a method of personalizing access to the Internet via the access network, and via a service provider dynamically allocating an Internet address to each user, said method comprising the following steps:

determining the identity of a user on the basis of the originating or destination address of an Internet packet sent or received by the user, and on the basis of the pair formed firstly by the user's call number on the access network, and secondly by the Internet address allocated to the user by the service provider; and

executing a service as a function of the identity determined in this way.

In an implementation, the method includes a step in which the service provider filters Internet packets.

In another implementation, the service includes tracing the identity of the user who sent or received filtered packets.

Advantageously, the service includes disconnecting the user who sent or received filtered packets.

The invention also provides a service for personalizing access to the Internet via an access network, and via a service provider dynamically allocating an Internet address to each user, said service comprising the following steps:

determining the identity of a user on the basis of the originating or destination address of an Internet packet sent or received by the user, and on the basis of the pair formed firstly by the user's call number on the access network, and secondly by the Internet address allocated to the user by the service provider; and

executing a service as a function of the identity determined in this way.

In an implementation, the service includes a step in which the service provider filters Internet packets.

It may also include tracing the identity of the user who sent or received filtered packets, or disconnecting the user who sent or received filtered packets.

The invention also provides a server providing access to the Internet, said server comprising means for dynamically allocating an Internet address to each user when said user makes a call over a network, said server having means for determining the identity of a user on the basis of the originating or destination address of an Internet packet sent or received by the user, and on the basis of the pair formed firstly by the user's call number on the access network, and secondly by the Internet address allocated to the user by the service provider, and having means for executing a service as a function of the identity determined in this way.

Advantageously, the server further includes a machine for filtering Internet packets.

In an implementation, the service includes tracing the identity of the user who sent or received filtered packets, or disconnecting the user who sent or received filtered packets.

### BRIEF DESCRIPTION OF THE DRAWING

Other characteristics and advantages of the invention will appear on reading the following description of implementations of the invention, given merely by way of example, when the network is the Internet, and with reference to the figures, in which:

FIG. 1 is a diagram of an Internet link; and

FIG. 2 is a diagram of the architecture of server of the invention for an Internet service provider.

### MORE DETAILED DESCRIPTION

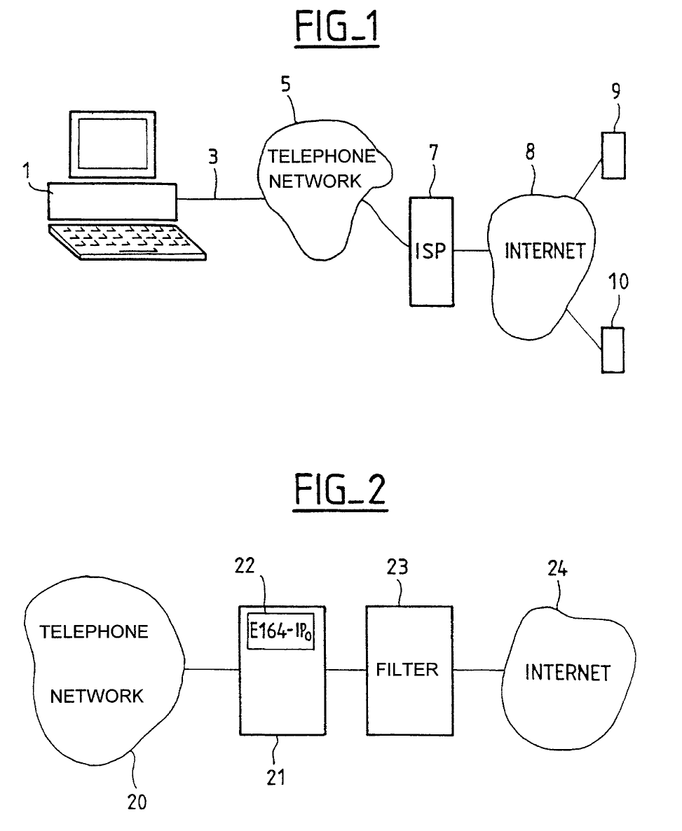

FIG. 1 shows a user terminal 1 connected as represented by the link 3 to an access network 5. In the example shown in FIG. 1, and in the description below, it is assumed that the network is a telephone network, such as the public switched telephone network, a public mobile network, or some other network. The user terminal may be connected to the network either directly, or via a private automatic branch exchange. FIG. 1 also diagrammatically shows an Internet service provider 7, and the Internet 8, with two contents providers 9 and 10. Between the user terminal 1 and the service provider (on the left of the service provider in FIG. 1), communication takes place over the channel used in the telephone network in question, the type of channel used being different depending on the network. Between the service provider and the contents provider, communication takes place in compliance with the Internet protocol.

A link is set up as follows. The user dials the call number of the service provider. On receiving the call from the user, the service provider authenticates the user if necessary and then dynamically allocates an Internet address enabling Internet transactions to be made. Once the user has been allocated an Internet address, the user can send messages using the Internet protocol, with the Internet originating address IP_{O} being the address allocated to the user by the service provider, and a destination address IP_{D} and message contents IP PDU (Internet Protocol Data Unit) being determined by the nature of the transaction. In return, the user receives Internet messages whose Destination Internet address is the address allocated dynamically by the service provider. At the end of the transaction, the user “hangs up”, and the service provider can re-use the previously-allocated address for some other transaction.

Thus, throughout the transaction, there is a one-to-one relationship between the user terminal's call number (the “E164 number” in international terminology) and the Internet address allocated dynamically by the service provider.

For filtering, the invention proposes to use means located at the service provider rather than at the user terminal. In addition, in order to leave a trace of the filtering, the invention proposes to use the existing pairing between the user's E164 call number and the Internet address dynamically allocated by the service provider.

FIG. 2 is a diagram showing the architectural structure of a server of the invention for a service provider. The service provider's server includes a first machine 21 known per se and connected to the telephone network 20, which machine performs all of the operations necessary for maintaining telephone communication with the user, allocates Internet addresses, and forwards the packets or datagrams sent by the user to the Internet 24 and received by the user from the Internet. In addition, the machine 21 includes storage means 22 for storing the E164-IP_{O} pair of each connected user. Furthermore, the service provider's server includes a filtering machine 23 which filters the Internet transactions from and to the first machine 21.

The service provider's server of the invention operates as follows. After the telephone link has been set up and an Internet address has been allocated, the transactions transmitted by the user may be subjected to first filtering based on the Destination Internet address. This first filtering makes it possible to eliminate or to reject transactions to undesirable sites, e.g. sites whose addresses are included in a list of pornographic sites, which list is updated by the service provider or by a service used by said service provider.

Internet transactions addressed to a user may also be subjected to contents filtering in the filtering machine. Such contents filtering makes it possible to filter transactions which do not come from a site whose address is identified as being undesirable, but whose contents do not satisfy filtering criteria, e.g. words included in a list are present in the IP PDU of the message.

The filtering characteristics to be applied may be a function of the user's subscription, or they may be determined as a function of the authentication of the user, e.g. of the user's password, if the same subscription covers a plurality of users. In addition, the invention may advantageously be used with the invention described in the patent application filed on the same date by the Applicant, under the title “Utilisation du couplage entre le numéro d'appel et l'adresse d'origine internet” (“The use of pairing between the call number and the Internet originating address”) (in-house reference Fo101493). That application proposes using the intelligent network services to allocate an Internet caller profile to each user, which profile contains information relating to the desired link, and, for example, filtering information. It is then possible to use the information contained in the Internet caller profile to parameterize the filtering implemented by the service provider. This makes it possible to adapt the filtering implemented to each user, independently of the chosen service provider.

In either case, the invention thus proposes to perform filtering at service provider level. It is then much more difficult to access the lists and to modify them than it is to access lists managed locally by a user as in prior art systems. In addition, the service provider offering the filtering service has more suitable means for updating the lists. Insofar as the service corresponds to a commitment from the service provider, the quality of the service should correspond to customer expectations, and is doubtless superior to that of prior art filtering.

In order to leave a trace of the filtering, the invention also proposes using the existing pairing between the user's E164 call number and the Internet address IP_{O} allocated dynamically by the service provider. This pairing makes it possible to determine which users have had transactions filtered.

For this purpose, when an outgoing transaction directed towards the Internet is subjected to filtering, typically filtering on the basis of destination Internet address, the filtering machine takes the originating Internet address. This address is the address allocated by the service provider to a user. The machine then consults the storage means 22 for storing E164-IP_{O} pairs, and deduces therefrom the call number of the user. It can also deduce therefrom the identity of the user, if the user was authenticated while the connection was being set up.

When an incoming transaction is subject to filtering, typically to IP PDU contents filtering, the filtering machine takes the destination Internet address. This address is the address allocated by the service provider to a user. In the same way, the machine then consults the storage means 22 for storing E₁₆₄-IP_{O} pairs, and deduces therefrom the call number of the user. It can also deduce therefrom the identity of the user, if the user was identified while the connection was being set up.

The service provider can thus keep a trace of the filtering. Such a trace makes it possible firstly to show customers of the service that it is effective, e.g. by making it possible for parents to see that calls by their children have been filtered. Such a trace may also be used for monitoring dissemination of information, e.g. for police purposes, for monitoring dissemination of banned information.

If the service provider is accessed via an intelligent network, and if the service provider can transfer information to a management unit for managing the intelligent network, it is also possible to use the filtering trace for other applications, as described in the above-mentioned patent application filed by the Applicant. The intelligent telephone network can then interrupt the call if it receives an indication that access is prohibited as sent by the service provider.

In such a case, it is also possible to use the identity of the user, obtained from the E₁₆₄-IP_{O} pair, to prevent any subsequent connection from the same caller, e.g. after one or more breaches of the filtering. It is then merely necessary for the service provider to transmit to the intelligent network the E₁₆₄ number of the user or the identity of the user in order to indicate that the service provider will refuse subsequent calls. The invention thus makes it possible to refuse telephone calls to the service provider, thereby avoiding burdening the telephone resources of the service provider with calls that must be rejected, for whatever reason.

The invention may be implemented by various physical means, as apparent to the person skilled in the art.

Naturally, the present invention is not limited to the implementations described and shown, but rather numerous variants of the invention are accessible to the person skilled in the art. It is thus possible to apply the invention to other types of network than the Internet. Mention is made of the E164 number merely by way of reference, because it is widely used. The method of the invention is also applicable to any extended E₁₆₄ numbering plan, or to any like number in the access network.

It is also possible to use a pair made up of the call number and of the Internet address allocated by the service provider for other types of added-value service.

1/ A method of personalizing access to the Internet via the access network, and via a service provider dynamically allocating an Internet address to each user, said method comprising the following steps:
determining the identity of a user on the basis of the originating or destination address of an Internet packet sent or received by the user, and on the basis of the pair formed firstly by the user's call number on the access network, and secondly by the Internet address allocated to the user by the service provider; and
executing a service as a function of the identity determined in this way.

2/ A method according to claim 1, including a step in which the service provider filters Internet packets.

3/ A method according to claim 2, wherein the service includes tracing the identity of the user who sent or received filtered packets.

4/ A method according to claim 2, wherein the service includes disconnecting the user who sent or received filtered packets.

5/ A service for personalizing access to the Internet via an access network, and via a service provider dynamically allocating an Internet address to each user, said service comprising the following steps:
determining the identity of a user on the basis of the originating or destination address of an Internet packet sent or received by the user, and on the basis of the pair formed firstly by the user's call number on the access network, and secondly by the Internet address allocated to the user by the service provider; and
executing a service as a function of the identity determined in this way.

6/ A service according to claim 5, including a step in which the service provider filters Internet packets.

7/ A service according to claim 6, including tracing the identity of the user who sent or received filtered packets.

8/ A service according to claim 6, including disconnecting the user who sent or received filtered packets.

9/ A server providing access to the Internet, said server comprising means for dynamically allocating an Internet address to each user when said user makes a call over a network, said server having means for determining the identity of a user on the basis of the originating or destination address of an Internet packet sent or received by the user, and on the basis of the pair formed firstly by the user's call number on the access network, and secondly by the Internet address allocated to the user by the service provider, and having means for executing a service as a function of the identity determined in this way.

10/ A server according to claim 9, including a machine for filtering Internet packets.

11/ A server according to claim 10, wherein the service includes tracing the identity of the user who sent or received filtered packets.

12/ A server according to claim 10, wherein the service includes disconnecting the user who sent or received filtered packets.
